(19) United States
(12) Patent Application Publication
(10) Pub. No.: US 2018/0360267 A1
(43) Pub. Date: Dec. 20, 2018

(54) Combination Outdoor Cooktop And Grill With Split Cover

(71) Applicants: Michael Reischmann, Eustis, FL (US); Phillip Williams, Clinton, CT (US)

(72) Inventors: Michael Reischmann, Eustis, FL (US); Phillip Williams, Clinton, CT (US)

(21) Appl. No.: 16/012,325

(22) Filed: Jun. 19, 2018

Related U.S. Application Data
(60) Provisional application No. 62/522,300, filed on Jun. 20, 2017.

(51) Int. Cl. A47J 37/07; A47J 37/06

(52) U.S. Cl. CPC A47J 37/0709; H05B 1/0266; A47J 37/0676

(57) ABSTRACT

A cooking apparatus including a housing having an outer perimeter and a first opening. A flange extending from the housing defines the outer perimeter. An inner peripheral edge defines the first opening. A cooktop element has a first peripheral edge, and at least one grill element has a second peripheral edge. A plurality of holes are in a grill plate of the at least one grill element to allow matter to pass through the holes. The cooktop element and the at least one grill element are mounted to the housing in the first opening with at least part of the first and second peripheral edges facing each other and at least part of the inner peripheral edge facing the first and second peripheral edges. The housing is configured to insert into an opening of a support structure with the flange preventing insertion all the way through the opening of the support structure.

### CROSS-REFERENCE TO RELATED APPLICATIONS

The present application claims priority to, and incorporates by reference herein, U.S. Provisional Patent Application No. 62/522,300 filed on Jun.20, 2017.

### FIELD OF THE INVENTION

The present invention relates to a cooking apparatus. More particularly, the present invention relates to a combination grill and cooktop cooking apparatus.

### BACKGROUND OF THE INVENTION

Although some gas grills are provided with a side burner, these are grills are usually stored outdoors. In some cases, grills are provided with split lids, but this simply divides two grilling surfaces into separate zones. In each case, the side burner is located separate from the grilling surface. Although the side burner may have its own cover, this cover is commonly shaped differently, with the burner cover generally being flat and space away from the hood or curved shaped cover of the grill.

Furthermore, many grills provide a side burner mounted on a separately attached wing so that the grill and heating unit are in a first housing, while the side burner is in a second housing that is separately attached to the first housing. The two housings meet at a seam, which may provide a less than desirable finish and may be more difficult to install and manufacture.

Accordingly, there is a need for a grill and cooktop unit that eliminates the need for a side burner by having the grill and cooktop elements mounted into one drop-in housing which in some aspects includes a split cover lid that may cover the grill and cooktop elements.

### SUMMARY OF THE INVENTION

Therefore, it is an object of the present invention to provide a drop-in grill and cooktop unit with the grill and cooktop adjacent to each other. It is another object of the present invention to provide a split cover lid that covers one or more of the grill and cooktop elements.

These and other objects are achieved by providing a cooking apparatus including a house having an outer perimeter and a first opening. An inner peripheral edge defines the first opening. A cooktop element has a first peripheral edge and a grill element has a second peripheral edge. A plurality of holes are in the grill element to allow matter to pass through the holes. The cooktop element and the grill element are mounted to the housing in the first opening such that at least part of the first and second peripheral edges are facing each other and such that at least part of the inner peripheral edge faces the first peripheral edge and the second peripheral edge. The first opening accounts for at least 60% of an area within the outer perimeter.

In some embodiments, the outer perimeter is defined by a flange that extends from the housing. The housing is configured to insert into an opening of a support structure such that the flange prevents insertion all the way through the opening of the support structure.

In some embodiments, a lid is divided in at least two sections along a dividing plane and at least one of the two sections is configured to cover the cooktop element and another one of the two sections is configured to cover the grill element. In some embodiments, the dividing plane passes between the cooktop element and the grill element. In other embodiments, the two sections are separately operable between open and closed positions. In yet other embodiments, the lid also includes at least one divider positioned on at least one of the two sections such that the area of the corresponding one of the two sections adjacent to the dividing plane is closed so that the at least one of the two sections is open around a perimeter that in the closed position aligns around the corresponding one of the cooktop element or the grill element.

In some embodiments, a second opening is positioned within the outer perimeter with at least one controller included in the second opening. The controller is configured to adjust a power level of one or more of the cooktop element and the grill element.

In some embodiments, the cooktop element and the grill element are electrically powered.

In some embodiments, an area of the first opening and the second opening accounts for at least 75% of the area within the outer perimeter.

In an alternative embodiment of the present invention, a cooking apparatus including a housing having an outer perimeter and a first opening is provided. A flange defines the outer perimeter. The flange extends from the housing. An inner peripheral edge defines the first opening. A cooktop element has a first peripheral edge and at least one grill element has a second peripheral edge. The cooktop element can be an induction cooktop. A plurality of holes are in a grill plate of the at least one grill element to allow matter to pass through the holes. The grill element may be electrically powered. The cooktop element and the at least one grill element are mounted to the housing in the first opening such that at least part of the first and second peripheral edges are facing each other and such that at least part of the inner peripheral edge faces the first peripheral edge and the second peripheral edge. The first opening accounts for at least 60% of an area within the outer perimeter. The housing is configured to insert into an opening of a support structure such that the flange prevents insertion all the way through the opening of the support structure.

In some embodiments, a second opening is positioned within the outer perimeter with at least one controller included in the second opening. The controller is configured to adjust a power level of one or more of the cooktop element and the at least one grill element.

In some embodiments, the cooktop and grill elements are electrically powered.

In some embodiments, an area of the first opening and the second opening accounts for at least 75% of the area within the outer perimeter.

In some embodiments, a lid is configured to cover the at least one grill element.

In another embodiment of the present invention, a cooking apparatus including a housing having an outer perimeter, and a first opening and a second opening positioned within the outer perimeter is provided. A flange defines the outer perimeter. The flange extends from the housing. An inner peripheral edge defines the first opening. A cooktop element has a first peripheral edge, a first grill element has a second peripheral edge, and a second grill element has a third peripheral edge. The first and second grill elements each have a plurality of holes that allows matter to pass through the holes. The cooktop element, the first grill element, and the second grill element are mounted to the housing in the first opening such that at least part of the first and second peripheral edges are facing each other, at least part of the second and third peripheral edges are facing each other, and at least part of the inner peripheral edge faces the first peripheral edge, the second peripheral edge, and the third peripheral edge. At least one controller is mounted to the housing in the second opening. The controller is configured to adjust a power level of one or more of the cooktop element, the first grill element, and the second grill element. The first opening accounts for at least 60% of an area within the outer perimeter. An area of the first opening and the second opening accounts for at least 75% of the area within the outer perimeter. The housing is configured to insert into an opening of a support structure such that the flange prevents insertion all the way through the opening of the support structure.

In some embodiments, the cooktop and grill elements are electrically powered.

In some embodiments, a lid is divided in at least two sections along a dividing plane that passes between the first and second grill elements. The at least two sections are separately operable between open and closed positions. At least one of the two sections is configured to cover the first grill element and another one of the two sections is configured to cover the second grill element.

In some embodiments, the lid also includes at least one divider positioned on at least one of the two sections such that the area of the corresponding one of the two sections adjacent to the dividing plane is closed so that the at least one of the two sections is open around a perimeter that in the closed position aligns around the corresponding one of the first or second grill elements.

In certain aspects a cooking zone divider system is provided with a lid for closing a cooking zone, the lid having a shape which is at least partially concave to define a cavity and having an edge which defines an opening. A holder is attached to the lid and a silicone element is configured to secure to and be removable from the holder. The silicone element extends across at least part of the cavity to at least partially separate the cavity in two or more sections on either side of the silicone element.

In certain aspects the silicone element includes a planar section and a connector section transverse to the planar section, the connector section configured to insert into the holder to secure said silicone element to said lid. In other aspects the lid is configured as a split lid with two or more separately openable portions and the holder is attached to one of the two or more separately openable portions to enable said silicone element to secure to the one of the two or more separately openable portions. In other aspects each of the two or more separately openable portions includes a holder and a corresponding silicone element. In certain aspects the silicone element when secured to the holder extends across the opening at a distance elevated with respect to the edge such that the silicone element is positioned away from direct contact with a heat source.

Other objects of the invention and its particular features and advantages will become more apparent from consideration of the following drawings and accompanying detailed description.

### BRIEF DESCRIPTION OF THE DRAWINGS

FIG. 1 is a front perspective view of a cooking apparatus having one cooktop and one grill element according to one embodiment of the present invention.

FIG. 2 is a front perspective view of a cooking apparatus having one cooktop and two grill elements according to another embodiment of the present invention.

FIG. 3 is a front perspective view of the cooking apparatus of FIG. 1 with a baffle installed.

FIG. 4 is a front perspective view of the cooking apparatus of FIG. 2 with baffles installed.

FIG. 5 is a front perspective view of a cooking apparatus having one cooktop element, two grill elements, and a lid that covers the grill elements according to another embodiment of the present invention.

FIG. 6 is a front perspective view of a support structure configured to receive the cooking apparatus of the present invention.

FIG. 7 is a side section view of how the baffle of FIGS. 3 and 4 may be installed on the lid.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

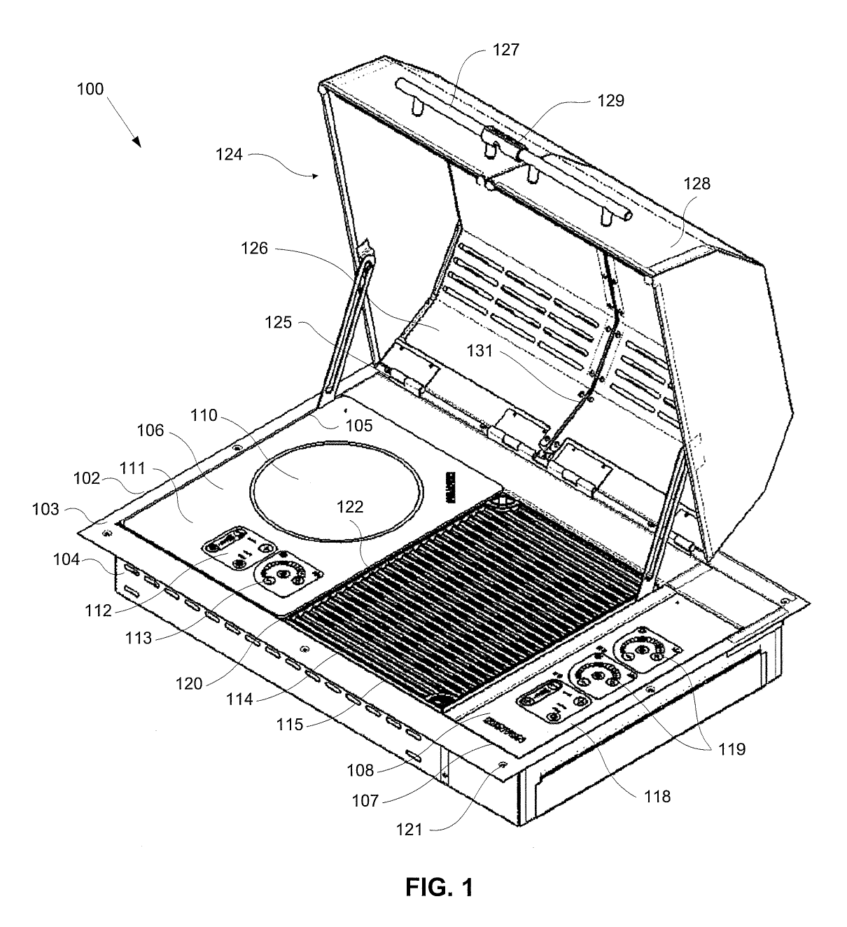

FIG. 1 shows a cooking apparatus 100 having a housing 102 with a flange 103 extending from an outer perimeter 104. A first opening 106 is defined by an inner peripheral edge 105 such that an area of the first opening 106 accounts for at least 60% of an area defined by the outer perimeter 104. In some embodiments, the area of the first opening 106 accounts for at least 70% of the area defined by the outer perimeter 104. In preferred embodiments, the area of the first opening 106 accounts for at least 80% of the area defined by the outer perimeter 104. A second opening 108 is provided with a second inner peripheral edge 107. In some embodiments, an area defined by the second opening 108 accounts for at least 5% of the area defined by the outer perimeter 104. In preferred embodiments, the area defined by the second opening 108 accounts for 10-20% of the area defined by the outer perimeter 104.

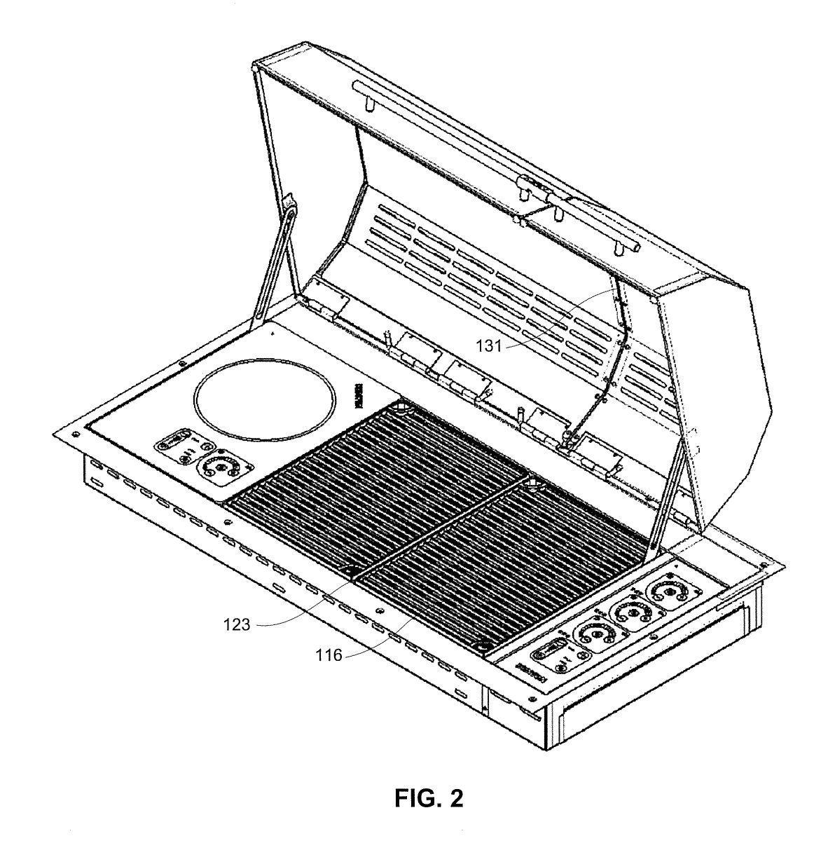

The first opening 106 contains at least one cooktop element 110 and at least one grill element 114 which may be electrically powered. The opening may be rectilinear. Intersections corners defined by various straight edges of the opening may have a small round to avoid sharp corners. In preferred embodiments, the cooktop element 110 is an electrically powered induction cooktop. In other embodiments, the cooktop element 110 is gas powered. In some embodiments, the cooktop element 110 includes a controller 112 positioned within the outer peripheral surface 111 of the cooktop element 110. The grill element 114 includes a removable grill grate with a plurality of drip holes 115 therein. Below the top surface of the grill grate is a heating element which remains securely attached to the grill element/housing. In preferred embodiments, the heating element is electrically powered. In other embodiments, the heating element is gas powered. In preferred embodiments, a second grill element 116 is provided to fit within the first opening 106, as depicted in FIG. 2. The cooktop element and grill element have edges which face each other or in certain aspects, contact each other when the two elements are positioned in the opening. The grill element may in addition to the removable grill grate/plate may have a removable drip pan which can be cleaned or may be designed as a disposable drip pan which can be discarded and replaced.

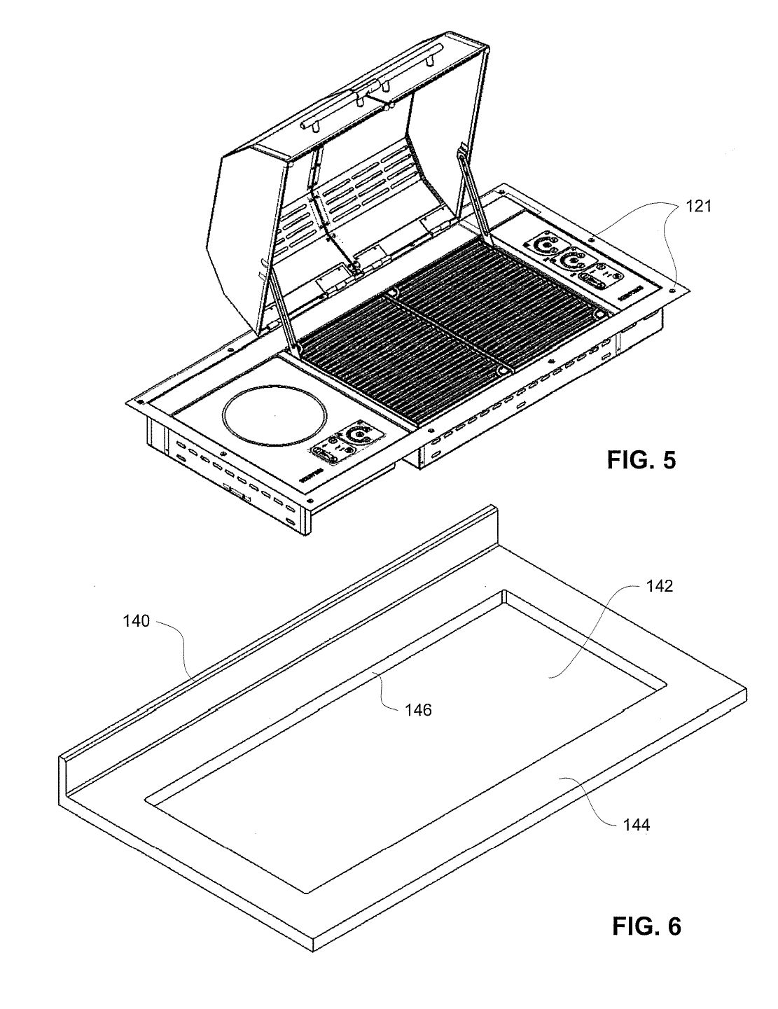

Preferably, the second opening 108 contains the controller 118 that allows a user to turn on/off and adjust the power/temperature of the grill element(s) 114/116. In some embodiments, the controller 118 also controls the cooktop element 110. In some embodiments, the cooktop element 110 is controlled by either controller 112 or controller 118. For example, FIG. 1 shows controller 118 with two separate zones 119, one for each cooking element 110 and 114, and controller 112 with one zone 113 for cooktop element 110. In other embodiments, controller 118 has three separate zones 119, one for each cooking element 110, 114, and 116. In preferred embodiments, the cooktop element 110 is controlled solely by controller 112, and controller 118 only controls grill element(s) 114/116, as depicted in FIG. 5.

Preferably, the first grill element 114 has an edge 120 that directly faces an edge 122 of the cooktop element 110 within the first opening 106. In some embodiments, the second grill element 116 has an edge 123 that directly faces the edge 120 of the first grill element 114 within the first opening 106. In preferred embodiments, when the cooking elements 110, 114, and 116 are mounted to the housing 102, the inner peripheral edge 105 of the housing 102 directly faces the edges 120, 122, and 123. In some embodiments, when the cooking elements 110 and 114 are mounted to the housing 102, the inner peripheral edge 105 of the housing 102 directly faces the edges 120 and 122. As can be seen the grill elements herein include grill plates which include the holes to allow grease to pass there through. In certain aspects, these grill grates/plates can be removed for easy cleaning.

Furthermore, the housing 102 contains electrical wiring for controllers 112 and 118 sufficient for controlling the temperature of the cooking elements 110, 114, and 116. In some embodiments, the housing 102 is provided with power wires that can be directly connected to an electrical system. In other embodiments, the power wires contain a plug for connecting the housing 102 to an electrical outlet.

Preferably, the housing 102 is a self-contained unit that can be dropped into an opening 142 of a support structure 140, as depicted in FIG. 6. The opening 142 of support structure 140 has a perimeter defined by an inner peripheral edge 146. In some embodiments, the perimeter of the opening 142 is in the range between the outer perimeter 104 of housing 102 and a perimeter defined by the outer edge of the flange 103 of housing 102. In preferred embodiments, the perimeter of the opening 142 is in the range between the outer perimeter 104 of housing 102 and 10% of the perimeter defined by the outer edge of the flange 103 of housing 102.

Support structure 140 has an upper surface 144 that interacts with the flange 103 of housing 102 such that the housing 102 drops into, rather than passing all the way through, support structure 140. In preferred embodiments, the flange 103 has a plurality of holes 121 adapted to receive fasteners, such as screw, nuts and bolts, nail, and the like, for securing the housing 102 to the support structure 140. In some embodiments, the support structure 140 is a countertop, such as those used in home kitchens, restaurants, boats, and RVs. In other embodiments, the support structure 140 is a fixed stand made at least partially of a stone or concrete based material that may be referred to as a “built in” outdoor cooking station. In other embodiments, the support structure 140 is a mobile stand, such as a wheeled frame for an outdoor grill.

The housing 102 also includes a lid 124 that is hingedly attached 125 to the rear of the housing 102. Preferably, the lid 124 is divided into at least two sections. The division of the at least two sections is located at least between two of the cooking elements 110, 114, and 116 such that a section of the lid 124 can be lifted to open less than all of the cooking elements 110, 114, and 116 to the surrounding environment. In some embodiments, the division between the lid sections is located between the cooktop element 110 and the first grill element 114, as shown in FIG. 1. In other embodiments, the division between the lid sections is located between the first grill element 114 and the second grill element 116, as shown in FIG. 2. In preferred embodiments, the lid 124 covers only the grill elements 114 and 116, and the division between the lid sections is located between the grill elements 114 and 116, as shown in FIG. 5.

In some embodiments, the lid 124 is closed on four sides and the top such that a baffle or divider 132 for the first section 126 is positioned at the division, as is a baffle 132 for the second section 128. The baffle may extend from the top of the lid down towards the grill/cooking surface fully or only part of the way. If it descends part of the way, this would ensure that the baffle remains separated from direct contact with the grill plate. As shown, the first section 126 and the second section 128 are divided along a dividing plane between the two sections that is located at line 131. In some embodiments, there is one lid section for each of the cooking elements 110, 114, and 116. It is also contemplated that each side opening of the lid (as opposed to the opening that is on the bottom) may include a baffle, such that facing openings have a baffle keeping in heat even if one lid section is opened. e.g. both lid sections shown in FIG. 5 may have a baffle installed such that if one is opened, the other continues to contain the heat within the other half of the grill over the un-opened zone. The cooking apparatus 100 of FIG. 2 may have three lid sections, one for the cooktop element 110, one for the first grill element 114, and one for the second grill element 116. In some embodiments, baffles 132 are placed between each of the cooktop elements 110, 114, and 116, as depicted in FIG. 4.

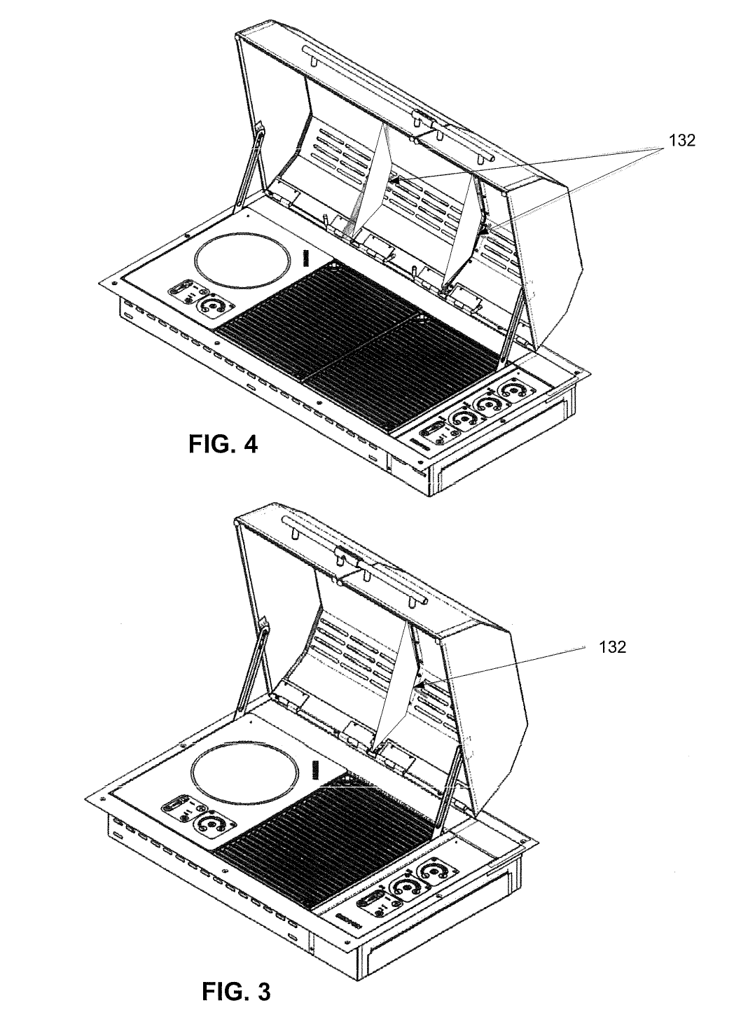

One example of the baffle 132 is depicted in FIGS. 3-4. In preferred embodiments, the baffle 132 is removable from its corresponding lid section 126/128. In such embodiments, the removability of the baffle 124 permits complete or partial use of the cooking elements and easy cleaning of the cooking elements. The baffle 124 insulates and isolates the relevant cooking element to reduce heat loss to other sections of the cooking apparatus 100, such as an unused adjacent cooking element. Additionally, the baffle 124 reduces or prevent splattering to adjacent cooking elements.

In some embodiments, the baffle 132 is permanently attached to the lid 124. In other embodiments, the baffle 132 is a fixed part of the lid 124. In some embodiments, the baffle 132 covers only a portion of the opening between the two lid sections 126 and 128. In other embodiments, the baffle 132 is sized to cover the entirety of the opening between lid section 126 and 128. In some embodiments, the baffle 124 is made of a silicone based material. In other embodiments, the baffle 124 is made of the same material as the rest of the lid 124, such as a metallic material.

In some embodiments, a tapered channel, or other attachment point, is located on one or more of the two lid sections 126 and 128. The baffle 128 has an edge configured to insert into the tapered channel, or to secure to the attachment point, such that the baffle 132 is secured to, but removable from, the corresponding lid section 126/128.

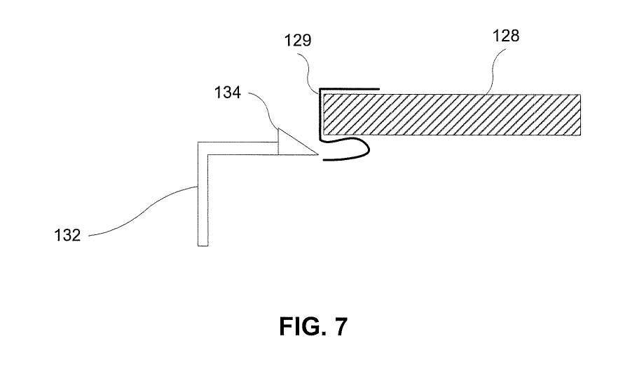

In preferred embodiments, the baffle 132 has an edge 134 that is slightly larger than the rest of the baffle 132, as depicted in FIG. 7. The edge 134 fits into a clip 129. In preferred embodiments, clip 129 is made of stainless steel. In some embodiments, clip 129 is made of another suitable material, such as a silicone based material. One side of the clip 129 secures to one section of the lid 124, such as lid section 128, and the other side of the clip 129 is configured to secure to the edge 134 of baffle 132. Thus, the baffle 132 is easily inserted into, and removable from, the clip 129, depending on which cooking element, or combination thereof, is activated. For example, if only grill element 116 is activated, a baffle 132 may be placed to close dividing plane 131 such that the single activated grill element 116 does not also heat up the adjacent grill element 114.

In preferred embodiments, the lid handle 127 is provided with a releasable attachment system 129 that slides from side-to-side to secure together all the lid sections or to separate the lid sections. For example, the drawing figures show the handle 127 as a generally round rod having a cylinder with a hole therein 129 positioned around the rod such that the cylinder can slide back and forth along the rod. In the example depicted in FIG. 1, when the cylinder with a hole therein 129 is moved left or right from the dividing plane 131, the lid sections 126 and 128 would be separated, whereas when the cylinder with a hole therein 129 is returned to the diving plane 131, the lid sections 126 and 128 would move together when the handle 127 is articulated.

As can be seen in FIG. 5, the system can also be configured such that there are three openings, one opening or the cooktop and a larger opening for two grill elements and a smaller opening for the grill element controller. A small metal bar separates the three openings. In certain aspects, the housing is made of stainless steel.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A cooking apparatus comprising:
a housing having an outer perimeter and a first opening which is substantially rectilinear;
an inner peripheral edge defining the first opening;
a cooktop element having a first peripheral edge and being an electrically powered induction cooktop;
a grill element having a second peripheral edge and a removable grill plate with plurality of holes therein to allow matter to pass there through, said grill element being electrically powered;
the cooktop element and the grill element mounted securely to the housing in the first opening such that at least part of the first and second peripheral edges are facing each other and such that at least part of the inner peripheral edge faces the first peripheral edge and the second peripheral edge;
wherein the first opening accounts for at least 60% of an area within the outer perimeter.

2. The cooking apparatus of claim 1, wherein the outer perimeter is defined by a flange that extends from the housing, the housing is configured to insert into an opening of a support structure such that the flange prevents insertion all the way through the opening of the support structure.

3. The cooking apparatus of claim 1, further comprising a lid divided in at least two sections along a dividing plane, wherein at least one of the two sections is configured to cover the cooktop element and another one of the two sections is configured to cover the grill element.

4. The cooking apparatus of claim 1, further comprising a second opening positioned within the outer perimeter and including at least one controller therein, the controller configured to adjust a power level of one or more of the cooktop element and the grill element.

5. The cooking apparatus of claim 4, wherein the cooktop element includes an integrated controller.

6. The cooking apparatus of claim 1, wherein the cooktop element includes an integrated controller.

7. The cooking apparatus of claim 4, wherein an area of the first opening and the second opening accounts for at least 75% of the area within the outer perimeter.

8. The cooking apparatus of claim 3, wherein the dividing plane passes between the cooktop element and the grill element.

9. The cooking apparatus of claim 3, wherein the two sections are separately operable between open and closed positions.

10. The cooking apparatus of claim 9, further comprising at least one divider positioned on at least one of the two sections such that the area of the corresponding one of the two sections adjacent to the dividing plane is closed so that the at least one of the two sections is open around a perimeter that in the closed position aligns around the corresponding one of the cooktop element or the grill element.

11. A cooking apparatus comprising:
a housing having an outer perimeter and a first opening;
a flange defining the outer perimeter, the flange extending from the housing;
an inner peripheral edge defining the first opening;
a cooktop element having a first peripheral edge and being an electrically powered induction cooktop;
at least one grill element having a second peripheral edge and a grill plate with plurality of holes therein to allow matter to pass therethrough, the at least one grill element being electrically powered;
the cooktop element and the at least one grill element mounted to the housing in the first opening such that at least part of the first and second peripheral edges are facing each other and such that at least part of the inner peripheral edge faces the first peripheral edge and the second peripheral edge;
wherein the first opening accounts for at least 60% of an area within the outer perimeter;
wherein the housing is configured to insert into an opening of a support structure such that the flange prevents insertion all the way through the opening of the support structure.

12. The cooking apparatus of claim 11, further comprising a second opening positioned within the outer perimeter and including at least one controller therein, the controller configured to adjust a power level of one or more of the cooktop element and the at least one grill element.

13. The cooking apparatus of claim 12, wherein the cooktop is controlled by an integrated controller separate from the controller.

14. The cooking apparatus of claim 11, wherein the cooktop is controlled by an integrated controller.

15. The cooking apparatus of claim 12, wherein an area of the first opening and the second opening accounts for at least 75% of the area within the outer perimeter.

16. The cooking apparatus of claim 11, further comprising a lid configured to cover the at least one grill element.

17. A cooking apparatus comprising:
a housing having an outer perimeter, and a first opening and a second opening positioned within the outer perimeter;
a flange defining the outer perimeter, the flange extending from the housing;
an inner peripheral edge defining the first opening;
a cooktop element having a first peripheral edge and being an electrically powered induction cooktop;
a first grill element having a second peripheral edge and a first grill plate with plurality of holes therein to allow matter to pass therethrough;
a second grill element having a third peripheral edge and a second grill plate with a plurality of holes therein to allow matter to pass therethrough;
the first and second grill elements being electrically powered;
the cooktop element mounted to the housing and positioned in the first opening;
the first grill element, and the second grill element mounted to the housing in the second opening such that at least part of the second and third peripheral edges are facing each other;
at least one controller mounted to the housing a third opening, the third opening within the outer perimeter and the controller configured to adjust a power level of one of more of the cooktop element, the first grill element, and the second grill element;
wherein the first and second openings combined account for at least 60% of an area within the outer perimeter;
wherein an area of the first, second and third openings combined account for at least 75% of the area within the outer perimeter;
wherein the housing is configured to insert into an opening of a support structure such that the flange prevents insertion all the way through the opening of the support structure.

18. The cooking apparatus of claim 17, wherein the cooktop is controlled by a cooktop controller which is positioned within the first opening and the controller controls the first and second grill elements.

19. The cooking apparatus of claim 17, further comprising a lid divided in at least two sections along a dividing plane that passes between the first and second grill elements, wherein the at least two sections are separately operable between open and closed positions, and wherein at least one of the two sections is configured to cover the first grill element and another one of the two sections is configured to cover the second grill element.

20. The cooking apparatus of claim 19, further comprising at least one divider positioned on at least one of the two sections such that the area of the corresponding one of the two sections adjacent to the dividing plane is closed so that the at least one of the two sections is open around a perimeter that in the closed position aligns around the corresponding one of the first or second grill elements.

21. A cooking zone divider system comprising:
a lid for closing a cooking zone, the lid having a shape which is at least partially concave to define a cavity and having an edge which defines an opening;
a holder attached to the lid;
a silicone element which is configured to secure to and be removable from the holder such that said silicone element extends across at least part of the cavity to at least partially separate the cavity in two or more sections on either side of said silicone element.

22. The cooking zone divider system of claim 21 wherein the silicone element includes a planar section and a connector section transverse to the planar section, the connector section configured to insert into the holder to secure said silicone element to said lid.

23. The cooking zone divider system of claim 21 wherein the lid is configured as a split lid with two or more separately openable portions and the holder is attached to one of the two or more separately openable portions to enable said silicone element to secure to the one of the two or more separately openable portions.

24. The cooking zone divider system of claim 23 wherein each of the two or more separately openable portions includes a holder and a corresponding silicone element such that when one of the one or more separately openable portions is opened, the other one of the one or more separately openable portions remains at least partially closed by the corresponding silicone element.

25. The cooking zone divider of claim 21 wherein the silicone element when secured to the holder extends across the opening at a distance elevated with respect to the edge such that the silicone element is positioned away from direct contact with a heat source.
